(19) United States
(12) Patent Application Publication
(10) Pub. No.: US 2007/0043197 A1
(43) Pub. Date: Feb. 22, 2007

(54) Polyurea polymers from secondary polyether polyamines

(75) Inventors: Mark L. Posey, Spring, TX (US); Kenneth M. Hillman, Spring, TX (US); Christopher J. Whewell, Georgetown, TX (US)

Correspondence Address: Huntsman Corporation;Legal Department, 10003 Woodloch Forest Drive, The Woodlands, TX, 77380, US

(73) Assignee: Huntsman Petrochemical Corporation, The Woodlands, TX (US)

(21) Appl. No.: 10/563,699

(22) PCT Filed: Jun. 29, 2004
(86) PCT No.: PCT/US04/20955

§ 371 Date: May 30, 2006

Related U.S. Application Data
(60) Provisional application No. 60/485,129, filed on Jul. 7, 2003.

(51) Int. Cl. C08G 18/00

(52) U.S. Cl. 528/44

(57) ABSTRACT

Provided herein are polyurea polymers made from an organic isocyanate and a polyamine component, wherein the polyamine component comprises a polyether polyamine in which the nitrogen atoms are secondary. The polyurea polymers of the invention are useful in a wide range of end-use applications and possess superior physical properties over polyurea polymers of the prior art. Methods for producing the polyurea polymers are also disclosed.

### FIELD OF THE INVENTION

The present invention relates generally to polyurea polymers. More specifically, it relates to the preparation of polymeric reaction products formed from the reaction between an organic isocyanate and a polyamine, wherein the polyamine is a secondary polyether polyamine.

### BACKGROUND INFORMATION

Polyurea polymers are polymers which are formed from the reaction of one or more organic isocyanates with one or more organic polyamines. Polyureas can be formed by bringing the organic isocyanate(s) component(s) in contact with the organic polyamine(s) using static mixing equipment, high-pressure impingement mixing equipment, low-pressure mixing equipment, roller with mixing attachments and simple hand mixing techniques, as such techniques are known to those skilled in the art. Polyurea polymers are useful in caulks, adhesives, sealants, coatings, foams, and many other applications. Specific examples include, but are not limited to, truck-bed liners, concrete coatings, metal coatings, concrete caulks, roof coatings, decorative coatings, and steel coatings.

Polyurea polymers are widely used in the coatings and paint industries. In many of the commercially-available isocyanate reactants used to form polyureas, the isocyanate content (“% NCO”) of the basic isocyanate building blocks is considered by some individuals skilled in the art to be inherently too high for good polyurea formation. In such cases, the isocyanate content may be reduced by pre-reacting the isocyanate with an amine or hydroxyl containing compound; however, some view altering the isocyanate content in this fashion to be unacceptable in view of the physical properties of the materials formed in this manner, and employ alternate chemistries to achieve their goals. Polyetheramines have also been used for reducing the isocyanate content of some isocyanates, such as those polyetheramines manufactured and sold by HUNTSMAN LLC of Houston, Tex. under the JEFFAMINE® trademarked series of products, and the various diamine polyetheramine products in the present specification are available from HUNTSMAN LLC.

### SUMMARY OF THE INVENTION

The present invention provides polyurea polymers made from reacting secondary polyether polyamines with one or more organic isocyanates. From a chemical standpoint, the secondary polyetheramine group can react with an isocyanate group only once. This fact inherently prevents the generally undesirable cross-linking reactions which may possibly occur at an amine site when primary amines are used, owing to the presence of two active hydrogens on the same nitrogen atom, which results in increased flexibility in the product, better polymer “memory”, and reduced isocyanate consumption on a per-mole basis.

Another advantage of preparing polymers in accordance with the present invention is the ability to form prepolymers with isocyanates where primary polyetheramines fail, which provides formulators with the ability to formulate with isocyanates such as trimers of hexamethylene diisocyanate, since the % NCO can now be manipulated into desired ranges.

### DETAILED DESCRIPTION

According to the present invention, secondary polyetheramine polyamines are employed in the production of polyurea polymers. A given secondary polyether polyamine differs from its primary analog in that the nitrogen atoms which in the primary amine have two hydrogen atoms attached to them, only have a single hydrogen attached to them, with one of the two hydrogens having been replaced by an alkyl group. We have witnessed cases where primary polyetheramines have a detrimentally-fast reaction rate which in many cases precludes the formation of polyurea materials having acceptable physical properties. We have discovered that the secondary polyether polyamines dramatically decrease reaction times as compared to primary amines, while simultaneously yielding polymeric ureas having advantageous physical properties over the polyurea polymers of the prior art, such as increased tear strengths. The discovery of advantageous physical properties is somewhat unexpected, in view of the known principle of hydrogen bonding, which is statistically decreased in the case of secondary amines versus primary amines, by the simple fact that the primary amines have more hydrogens available for hydrogen bonding. In fact, when a secondary amine is reacted with an isocyanate, the hydrogen atom on the secondary amine is consumed; thus, the total hydrogen content of a polyurea produced using a secondary amine is less than that of a polyurea polymer produced using the same isocyanate and the corresponding primary amine. Importantly, the increase in tear strengths we have observed occur with no significant losses in the tensile strengths of the materials. The present invention renders accessible many new end use applications in which secondary polyether polyamines are used in place of primary polyetheramines, to confer the benefits of polyetheramines without the adverse high reactivity owing to the presence of the primary amine function in the prior art materials and processes.

In one embodiment of the present invention, the secondary polyether polyamines are used to replace some primary polyetheramines in the amine blend used in the production of a polyurea formulation. This results in an increase in the time before the polyurea is completely polymerized “cured”, which allows the polymer precursors to flow smoothly to provide coatings and manufactures to be produced with fewer internal and surface defects. The end user or applicator is afforded more time to work with the fluid polymer before its viscosity has increased to the point at which it can no longer worked, which is sometimes referred to as the “work time”.

In another embodiment, secondary polyether polyamines may be used to form pre-polymers with organic isocyanates for use in subsequently providing other polyurea polymers. Many organic isocyanates cannot successfully be reacted to form prepolymers with primary polyetheramines due to crosslinking in the prepolymer. Another benefit of the present invention which we have discovered is that it is now possible to provide prepolymers from secondary polyether polyamines, for cases in which the analogous primary polyetheramine fails to yield such a prepolymer.

Secondary polyether polyamines may be obtained by reacting primary polyetheramines with a di-alkyl ketone, aldehyde, or cyclic ketone or other carbonyl-function containing molecule in the presence of hydrogen and a catalyst. The secondary polyether polyamines so obtained are light in color, have low viscosities, and remain liquid at room temperature, which is a marked advantage which will be greatly appreciated by industrial producers of polyurea polymers.

As used in the present specification and the appended claims, the term “organic isocyanate” includes a wide variety of materials recognized by those skilled in the art as being useful in preparing polyurea and polyurethane polymer materials. Included within this definition are both aliphatic and aromatic isocyanates, as well as one or more prepolymers or quasi-prepolymers prepared using such isocyanates as a starting material, as is generally well known in the art. Preferred examples of aliphatic isocyanates are of the type described in U.S. Pat. No. 4,748,192, as well as aliphatic di-isocyanates and, more particularly, the trimerized or the biuretic form of an aliphatic di-isocyanate, such as hexamethylene di-isocyanate (“HDI”), and the bi-functional monomer of the tetraalkyl xylene di-isocyanate, such as the tetramethyl xylene di-isocyanate. Cyclohexane di-isocyanate is also to be considered a useful aliphatic isocyanate. Other useful aliphatic polyisocyanates are described in U.S. Pat. No. 4,705,814. They include aliphatic di-isocyanates, for example, alkylene di-isocyanates with 4 to 12 carbon atoms in the alkylene radical, such as 1,12-dodecane di-isocyanate, 1,4-tetramethylene di-isocyanate, and 1,6-hexamethylene di-isocyanate. Also useful are cycloaliphatic di-isocyanates, such as 1,3 and 1,4-cyclohexane di-isocyanate as well as any mixture of these isomers, 1-isocyanato-3,3,5-trimethyl-5-isocyanatomethylcyclohexane (isophorone di-isocyanate); 4,4′-,2,2′- and 2,4′-dicyclohexylmethane di-isocyanate as well as the corresponding isomer mixtures, and the like.

A wide variety of aromatic polyisocyanates may also be used to form a polymer according to the present invention, and typical aromatic polyisocyanates include p-phenylene di-isocyanate, polymethylene polyphenylisocyanate, 2,6-toluene di-isocyanate, dianisidine di-isocyanate, bitolylene di-isocyanate, naphthalene-1,4-di-isocyanate, bis(4-isocyanatophenyl)methane, bis(3-methyl-3-iso-cyanatophenyl)methane, bis(3-methyl-4-isocyanatophenyl)methane, and 4,4′-diphenylpropane di-isocyanate, as well as MDI-based quasi-prepolymers such as those available commercially as RUBINATE® 9480, RUBINATE® 9484, and RUBINATE® 9495 from Huntsman International, LLC.

Other aromatic polyisocyanates used in the practice of the invention are methylene-bridged polyphenyl polyisocyanate mixtures which have a functionality of from about 2 to about 4. These latter isocyanate compounds are generally produced by the phosgenation of corresponding methylene bridged polyphenyl polyamines, which are conventionally produced by the reaction of formaldehyde and primary aromatic amines, such as aniline, in the presence of hydrochloric acid and/or other acidic catalysts. Known processes for preparing polyamines and corresponding methylene-bridged polyphenyl polyisocyanates therefrom are described in the literature and in many patents, for example, U.S. Pat. Nos. 2,683,730; 2,950,263; 3,012,008; 3,344,162 and 3,362,979. Usually methylene-bridged polyphenyl polyisocyanate mixtures contain about 20 to about 100 weight percent methylene di-phenyl-di-isocyanate isomers, with the remainder being polymethylene polyphenyl di-isocyanates having higher functionalities and higher molecular weights. Typical of these are polyphenyl polyisocyanate mixtures containing about 20 to about 100 weight percent di-phenyl-di-isocyanate isomers, of which about 20 to about 95 weight percent thereof is the 4,4′-isomer with the remainder being polymethylene polyphenyl polyisocyanates of higher molecular weight and functionality that have an average functionality of from about 2.1 to about 3.5. These isocyanate mixtures are known, commercially available materials and can be prepared by the process described in U.S. Pat. No. 3,362,979. The present invention includes the use of mixtures of isomers of isocyanates, which are produced simultaneously in a phosgenation reaction, or any blend of two or more isocyanates (including two or more mixtures of isocyanates, or a single isocyanate with a mixture of isocyanates) which are produced using two or more separate phosgenations. One preferred aromatic polyisocyanate is methylene bis(4-phenylisocyanate) or “MDI”. Pure MDI, quasi-prepolymers of MDI, modified pure MDI, etc. are useful to prepare materials according to the invention. Since pure MDI is a solid and, thus, often inconvenient to use, liquid products based on MDI or methylene bis(4-phenylisocyanate) are also useful herein. U.S. Pat. No. 3,394,164 describes a liquid MDI product. More generally, uretonimine modified pure MDI is included also. This product is made by heating pure distilled MDI in the presence of a catalyst. The liquid product is a mixture of pure MDI and modified MDI. The term organic isocyanate also includes quasi-prepolymers of isocyanates or polyisocyanates with active hydrogen containing materials. Any of the isocyanates mentioned above may be used as the organic isocyanate component in the present invention, either alone or in combination with other aforementioned isocyanates.

The term “secondary polyether polyamines” when used in this specification and the claims appended hereto means those secondary amines within the definitions of formula: 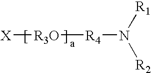
in which R₁ and R₂ are each independently selected from the group consisting of hydrogen; an alkyl group having 1, 2, 3, 4, 5, 6, 7, 8, 9, or 10 carbon atoms, whether straight-chain or branched; or a radical of the formula: 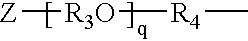
in which R₃ in each occurrence may be an alkyl group having any number of carbon atoms selected from 1, 2, 3, 4, 5, or 6, straight-chain or branched; R₄ in each occurrence is a straight-chain or branched alkyl bridging group having 1, 2, 3, 4, 5, or 6 carbon atoms; Z is a hydroxy group or alkyl group containing 1, 2, 3, 4, 5, or 6 carbon atoms, straight-chain or branched; q is any integer between 0 and 400; and wherein X is any of:
i) a hydroxy group or an alkyl group having any number of carbon atoms selected from 1, 2, 3, 4, 5, or 6; or
ii) a group 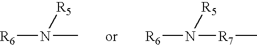
in which R₅ and R₆ are each independently selected from the group consisting of: hydrogen; an alkyl group having 1, 2, 3, 4, 5, 6, 7, 8, 9, or 10 carbon atoms, whether straight-chain or branched; or 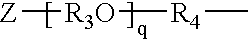
as defined above in which Z is a hydroxy group or an alkoxy group having 1, 2, 3, 4, 5, or 6 carbon atoms, and in which R₇ is a straight-chain or branched alkylene bridging group having 1, 2, 3, 4, 5, or 6 carbon atoms; or
iii) a moiety of the formula: 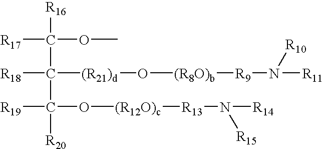
in which R₁₀, R₁₁, R₁₄, and R₁₅ are each independently selected from the group of: hydrogen; an alkyl group having 1, 2, 3, 4, 5, or 6 carbon atoms, straight-chain or branched; the moiety 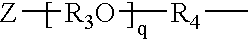
as defined above in which Z is a hydroxy or alkoxy group having 1, 2, 3, 4, 5, or 6 carbon atoms; R₈ and R₁₂ are each independently alkyl groups having 1, 2, 3, 4, 5, or 6 carbon atoms, straight-chain or branched; R₉, R₁₃, and R₂₁ are each independently selected from a straight-chain or branched alkyl bridging linkage having 1, 2, 3, 4, 5, or 6 carbon atoms; R₁₆, R₁₇, R₁₈, R₁₉, R₂₀ are each independently selected from hydrogen or an alkyl group having 1, 2, 3, 4, 5, or 6 carbon atoms; d is 0 or 1; a is any integer between 0 and 100, with the proviso that when X is a moiety of the formula given in id) above, b and c may each independently be any integer in the range of 0 to 390, and the sum of a+b+c is any number between 2 and 400. According to one preferred form of the invention, such secondary polyetheramine polyamines are diamines. According to another form of the invention, such secondary polyetheramine polyamines are triamines. According to another form of the invention, the nitrogen atoms which are secondary in such secondary polyetheramine polyamines have an alkyl group appended to them which is selected from the group consisting of: isopropyl, 2-butyl, 4 methyl-2-pentyl, and cyclohexyl.

To provide a polyurea polymer according to the present invention, an organic isocyanate is mixed with a secondary polyetheramine polyamine, either manually or automatically, using conventional production equipment. Typically, during the manufacturing process for producing polyurea polymers according to the prior art, the organic isocyanate and polyamine components are normally kept separated from one another, such as by being contained in separate containers, until being mixed at the time of use. The polyamine is typically a blend of amines, pigments and other additives, and is sometimes referred to by those skilled in the art as the “resin blend”. The resin blend is usually prepared in advance of the mixing of the organic isocyanate and the amines component, and well mixed to ensure uniform dispersion of the pigments and amines, using mixing techniques which are known to those skilled in the art.

According to one preferred form of the invention, secondary polyetheramine polyamines are included in the resin blend. The secondary polyether polyamines may be used in place of primary polyetheramines of the prior art in an established formulation, on a mole-equivalent basis (based on active hydrogen content), or as a blend with primary polyetheramines, polyetheramine polyamines, other known amines, other known polyamines, and any mixture of two or more of the foregoing. Thus, the amine component of a polyurea formed in accordance with the present invention includes any amine from which a polyurea may be prepared which has an active hydrogen atom attached to a nitrogen atom in its molecular structure. For purposes of this specification and the appended claims, the words “active hydrogen atom” is a hydrogen atom which is bonded to a nitrogen atom, and which hydrogen atom is capable of participating in the Zerevitinov reaction (Th. Zerevitinov, Ber. 40, 2023 (1907)) to liberate methane from methylmagnesium iodide. In addition, chain extenders are often employed where hard coatings are required but can be replaced in part or in whole by secondary polyetheramines.

In another embodiment, secondary polyetheramines are used to form a prepolymer by reaction with an isocyanate. This can be accomplished by slowly adding the secondary polyetheramine to one or more organic isocyanates with vigorous mixing to control polymerization to a pre-selected degree. By varying the ratio of amine to isocyanate, a range of isocyanate prepolymers can be produced having % NCO contents of nearly any value, but most preferably from about 3% to about 31% can be formed. The new prepolymer isocyanate is subsequently contacted with a resin blend to form a polyurea polymer.

The reduction in the speed of the reaction of the secondary polyether polyamines during production of polyurea polymers according to the present invention is a key advantage which enables formation of molded articles and coatings having higher structural integrity, and especially in the end use of coatings, in which superior tear strengths heretofore unobserved in these coatings have been attained. Increased work time through the slower cure rate allows for smoother and glossier coatings to form, which are also aesthetically more appealing. Slower reaction rates allow for production of caulk and sealant formulations having sufficient gel time for practical use. Longer working times will also have benefit in adhesive and sealant applications where having more time to bring two surfaces into contact is critical to success.

The attached tables provide formulations according to the present invention and physical properties of the resulting materials. We have included comparative formulations from the prior art to show the benefits and differences with formulations utilizing secondary polyether polyamines. Included are three working examples of a prepolymer formed with product XTJ-576 that would not even be possible to produce using primary polyetheramines, owing to gellation. The secondary polyether polyamines set forth in this specification are all poly N-isopropyl-substituted analogs of what we prefer to term primary polyetheramines, and which Huntsman has produced and sold for many years.

### Experimental

As previously mentioned, the present invention relates to the formation of polyurea polymers, which requires the mixing of an isocyanate component (“A” component) and an amino compound (“B” component), which amino compound, according to the invention, is preferably a secondary polyether polyamine within the definitions above.

The (A) component and (B) component of a polyurea polymer produced according the invention are combined or mixed under high pressure. It is most preferred that they are impingement-mixed directly in the high-pressure equipment, such as, for example, a GUSMER® H-V proportioner (or a GUSMER® H20/35) fitted with a GUSMER® Model GX-7 spray gun, where open-mold work or coating is desired. The ratios of these components are adjusted such that they are processed at a 1:1 volume ratio at an index between 0.9 and 1.20. These systems can be processed within a pressure range of 1000-3500 psi and a temperature range of 120-180° F. with preferred processing conditions including pressures between 1500-2500 psi and temperature of 140-170° F.

Thus, the useful temperature range at which a flexible polyurea may be prepared according to the invention is any temperature between 120-180° F. The useful pressure range at which a polyurea may be prepared according to the invention is any pressure between 1000-3500 psi. However, one of ordinary skill recognizes that temperatures and pressures outside these ranges are also useful; thus the present invention is not necessarily limited to being practiced within these parameters.

For the preparation of sprayed samples according to the invention described in the tables which follow, a GUSMER® Marksman (or H20/35) proportioning unit (plural component) was used, fitted with a GUSMER® GX-7-400 spray gun. The equipment was set so as to process each example at an isocyanate to resin blend volume ratio of 1.00. Spray processing pressure was maintained at 1500 psi to 2500 psi on both the isocyanate and resin blend components. Block heat, as well as hose heat, was set at 160° F.

In the tables which follow, product XTJ-576 is d-isopropyl substituted JEFFAMINE® D-2000; product XTJ-584 is di-isopropyl substituted JEFFAMINE® D-230; product XTJ-585 is di-isopropyl substituted JEFFAMINE® D-400; product XTJ-586 is tri-isopropyl substituted JEFFAMINE® T-403; and the product designated as IPDI is isophorone diisocyanate.

Throughout this specification various test results are set forth, and the following test methods were employed in each occurrence of the following herein:

| Test | Method |
|---|---|
| Tensile strength | ASTM D-638 |
| elongation max | ASTM D-638 |
| tear strength | ASTM D-624 |
| string gel | see below |
| tack free time | see below |

The string gel and tack free time test methods are now described. The methods used depend upon the method of preparing the polyurea polymers. For the spray method, a vertical surface is used as a target, which is typically a piece of cardboard or other disposable material. The spray gun is triggered to dispense polyurea onto the cardboard at the same time as the stop watch is started. Spray is continued until sufficient material has built up to begin running downward. This is usually less than 2 seconds. “Gel Time” is the elapsed time from the start of the watch until the polyurea material is no longer running down the vertical surface, i.e. the polyurea has gelled to the point that it no longer flows under gravity. “Tack Free” is the time elapsed when the polyurea surface is no longer sticky when touched by a gloved finger with light pressure.

For the static mix method, because static mix samples are normally dispensed into a horizontal mold, and therefore don't run, a different measurement is used and called “String gel” rather than just “Gel”. The stopwatch is started when the polyurea is begun to be dispensed into the mold. The polyurea surface in the area first coated is then touched lightly with a wooden tongue depressor and then lifted vertically. The test area must be from the first material because as many as 10-20 seconds can pass from the start to the end of dispensing of the polyurea into the mold. In the early stages of cure, the polyurea will stick to the depressor and rise up with the vertical motion pulling a “string” which eventually breaks loose. The touch and lift procedure is repeated until such time as the polyurea surface no longer pulls vertically with the tongue depressor. The surface can still be tacky and soft at this point. “Tack Free” is the time elapsed at which point the polyurea surface is no longer sticky when touched by a gloved finger with light pressure. Also, light pressure with a gloved finger should not create a “fingerprint” or depression in the surface. Even though the surface is “tack free” it may not be strong enough at this point to take a significant force without flowing or deforming.

Polyurea polymers were prepared by mixing an “A” component comprising an organic isocyanate and a “B” component comprising a polyetherpolyamine according to the proportions of ingredients specified in Table I. In Table I, DESMODUR® N-3400 is an HDI trimer isocyanate available from Bayer Corporation of Pittsburgh, Pa. (USA). The JEFFAMINE® trademarked amine products are available from Huntsman LLC of Houston, Tex. In Table I below, sample 1 was produced using primary amines JEFFAMINE® D-2000 amine, JEFFAMINE® D-400 amine, in the presence of a chain extender JEFFLINK® 754 amine. Sample 2 was produced using the experimental material XTJ-585 (secondary amine form of JEFFAMINE® D-400 amine having a single isopropyl group on each of the amine nitrogen atoms) in place of the JEFFAMINE® D-400 amine. The polyurea polymers produced using such raw materials had a tear strength of 824 pli, which is a phenomenally-high tear strength for a polyurea polymer.

TABLE I

| | Sample ID | |
|---|---|---|
| | 1 | 2 |
| A side | | |
| DESMODUR ® N-3400 isocyanate | 100 | 100 |
| % NCO (calc.) | 21.76 | 21.76 |
| B side | | |
| JEFFAMINE ® D-2000 amine | 15 | 5 |
| JEFFAMINE ® D-400 amine | 43 | 0 |
| XTJ-585 | 0 | 45 |
| JEFFLINK ® 754 amine | 42 | 50 |
| volume Ratio | 1.01 | 1.01 |
| weight ratio (NCO/resin) | 1.24 | 1.30 |
| Index | 1.15 | 1.19 |
| Tensile Strength, psi | cures too rapid to | 3747 |
| Max elongation (%) | make samples | 81 |
| Tear strength (lbs/linear inch) | | 824 |
| Shore D, O sec/10 sec. | — | 77/67 |
| static mix@25° C. | | |
| String Gel (sec.) | 3 | 14 |
| Tack-free time (sec.) | 15 | 28 |

In table II below, sample 3 was produced using primary amines JEFFAMINE® D-2000 amine and JEFFAMINE® D-230 amine, in the presence of a chain extender JEFFLINK® 754 amine. Sample 4 was produced using the experimental material XTJ-584 (secondary amine form of JEFFAMINE® D-230 amine having a single isopropyl group on each of the amine nitrogen atoms) in place of the JEFFAMINE® D-230 amine. The polyurea polymers produced using such raw materials had a tear strength of 943 pli, which is an awesome, and heretofore unattainable tear strength for a polyurea polymer.

TABLE II

Sample ID

| | 3 | 4 |
|---|---|---|
| A side | | |
| Desmodur ® N-3400 isocyanate | 100 | 100 |
| % NCO (calc.) | 21.76 | 21.76 |
| B side | | |
| JEFFAMINE ® D-2000 amine | 30 | 13 |
| JEFFAMINE ® D-230 amine | 25 | 0 |
| XTJ-584 | 0 | 42 |
| JEFFLINK ® 754 amine | 45 | 45 |
| volume Ratio | 1 | 1 |
| weight ratio (NCO/resin) | 1.22 | 1.28 |
| Index | 1.06 | 1.06 |
| Tensile Strength, psi | cures too rapid to | 3883 |
| Max elongation (%) | make samples | 55 |
| Tear strength (lbs/linear inch) | | 943 |
| Shore D, O sec/10 sec. | — | 74/67 |
| static mix@25° C. | | |
| String Gel (sec.) | instant gel | 10 |
| Tack-free time (sec.) | | 17 |

In table III below, sample 5 was produced using primary amines JEFFAMINE® D-2000 amine, JEFFAMINE® D-400 amine, in the presence of a chain extender JEFFLINK® 754 amine. Sample 6 was produced using the experimental material XTJ-585 (secondary amine form of JEFFAMINE® D-400 amine having a single isopropyl group on each of the amine nitrogen atoms) in place of the JEFFAMINE® D-400 amine. The polyurea polymers produced using the secondary polyether polyamine materials had a tear strength of 692 pli comp, compared to that produced using the primary amine which was only 457, thus illustrating again the unusually-high and unexpected tear strength in polyurea materials manufactured using secondary polyether polyamines.

TABLE III

Sample ID

| | 5 | 6 |
|---|---|---|
| A side | | |
| DESMODUR ® N-3400 | 100 | 100 |
| isocyanate | | |
| % NCO (calc.) | 21.76 | 21.76 |
| B side | | |
| JEFFAMINE ® D-2000 amine | 15 | 10 |
| JEFFAMINE ® D-400 amine | 20 | 0 |
| XTJ-585 | 0 | 25 |
| JEFFLINK ® 754 amine | 65 | 65 |
| volume Ratio | 1 | 1 |
| weight ratio (NCO/resin) | 1.27 | 1.29 |
| Index | 1.05 | 1.09 |
| Tensile Strength, psi | 7153 | 5166 |
| Max elongation (%) | 10 | 13 |
| Tear strength (lbs/linear inch) | 457 | 692 |
| Shore D, O sec/10 sec. | 75/70 | 78/73 |
| spray @ 160° F. | | |
| Gel time (sec.) | 1 | 2 |
| Tack-free time (sec.) | 7 | 9 |

Table IV shows physical properties and amounts of raw materials for preparing a variety of polyurea polymers. In this table IV, the crosslinker material CLEARLINK® 1000 amine (originally a UOP product) is available from Dorf-Ketal company of India. As can be seen from table IV, sample 7 which was prepared using a primary amine was too reactive to provide acceptable spray coatings. All of the spray coatings of examples 8, 9, 10, and 11 which were prepared using secondary polyether polyamines had tear strengths which are higher than the high end of the range of tear strengths of normal polyurea polymers.

TABLE IV

| | Sample ID | | | | |
|---|---|---|---|---|---|
| | 7 | 8 | 9 | 10 | 11 |
| A side | | | | | |
| Desmodur ® | 100 | 100 | 100 | 100 | 100 |
| N-3400 isocyanate | | | | | |
| % NCO (calc.) | 21.76 | 21.76 | 21.76 | 21.76 | 21.76 |
| B side | | | | | |
| JEFFAMINE ® | 22 | 10 | 10 | 0 | 10 |
| D-2000 amine | | | | | |
| JEFFAMINE ® | 10 | 0 | 0 | 0 | 0 |
| D-230 amine | | | | | |
| XTJ-584 | 0 | 10 | 10 | 20 | 10 |
| JEFFAMINE ® | 18 | 0 | 0 | 0 | 0 |
| T-403 amine | | | | | |
| XTJ-586 | 0 | 30 | 0 | 20 | 0 |
| T-403-MIBK | 0 | 0 | 0 | 0 | 30 |
| XTJ-566-acetone | 0 | 0 | 30 | 0 | 0 |
| JEFFLINK ® | 45 | 45 | 45 | 0 | 45 |
| 754 amine | | | | | |
| CLEARLINK ® | 0 | 0 | 0 | 55 | 0 |
| 1000 amine | | | | | |
| TiO₂ | 5 | 5 | 5 | 5 | 5 |
| volume Ratio | 1 | 1 | 1 | 1 | 1 |
| weight ratio | 1.17 | 1.22 | 1.22 | 1.21 | 1.21 |
| (NCO/resin) | | | | | |
| Index | 1.05 | 1.09 | 1.10 | 1.12 | 1.15 |
| Tensile Strength, psi | cures too | 3486 | 3926 | 5954 | 3401 |
| Max elongation (%) | rapid to | 79 | 38 | 15 | 96 |
| Tear strength | make | 689 | 709 | 752 | 748 |
| (lbs/linear inch) | samples | | | | |
| Shore D, O sec/10 sec. | — | 72/64 | 73/66 | 72/68 | 73/64 |
| spray @ 160° F. | | | | | |
| Gel time (sec.) | instant | 3 | 3.5 | 4 | 3 |
| Tack-free time (sec.) | | 7 | 17 | 9 | 15 |

Polyurea polymers produced according to the present invention using secondary polyetherpolyamines are suitable for a wide range of end uses, including without limitation, the following: coatings for concrete, such as bridges, bridge pylons, bridge decks, water-proofing layers, tunnels, manholes, secondary containment, skid resistant layers, flooring, garages, aircraft hangars, sewer rehabilitation, water pipes, concrete pipes; coatings for metals, including masking layer for etching process, corrosion protection, ship hulls, ship decks, aircraft carrier decks, submarines, other military vehicles, helicopter rotor blades, bridges, structural members, playgrounds, automotive, truck-bed liners, under-carriage, outer body, rail-road cars and hoppers, trailers, flat bed trucks, 18 wheelers, large dirt moving equipment, rollers, aerospace, tank coatings (inside and out), pipe coating (inside and out); coatings for other substrates such as fiberglass boats, pavement marking, concrete marking, decorative/protective layer over various substrates for movie sets, amusement parks, parade floats, paint-ball props, electronics encapsulation, roofing topcoat for various substrates; coatings for polystyrene, wax, ice, or other media used in prototyping; manufacture of molded articles, such as reaction injection molded and products made using other molding techniques, prototype parts, shoe components, golf balls, decorative parts, automotive parts, bumpers, hubcaps; polyurea foam for sound insulation; thermal insulation; shock absorption; and other end use applications where polyurethane foam is known to be useful in the various arts; caulks for concrete floors and other architectural applications in which a sealant is employed, adhesives for bonding two components in a wide variety of substrates and applications where adhesives are normally employed; and sealants for a wide variety of non-architectural applications, such as on board of sea-going vessels.

Consideration must be given to the fact that although this invention has been described and disclosed in relation to certain preferred embodiments, obvious equivalent modifications and alterations thereof will become apparent to one of ordinary skill in this art upon reading and understanding this specification and the claims appended hereto. The present disclosure includes the subject matter defined by any combination of any one of the various claims appended hereto with any one or more of the remaining claims, including the incorporation of the features and/or limitations of any dependent claim, singly or in combination with features and/or limitations of any one or more of the other dependent claims, with features and/or limitations of any one or more of the independent claims, with the remaining dependent claims in their original text being read and applied to any independent claim so modified. This also includes combination of the features and/or limitations of one or more of the independent claims with the features and/or limitations of another independent claim to arrive at a modified independent claim, with the remaining dependent claims in their original text being read and applied to any independent claim so modified. Accordingly, the presently disclosed invention is intended to cover all such modifications and alterations, and is limited only by the scope of the claims which follow, in view of the foregoing and other contents of this specification.

What is claimed is:

1) A process for the formation of a polyurea polymer which comprises the steps of:
A) providing a first composition which comprises one or more organic isocyanates;
B) providing a second composition which comprises one or more polyether polyamino compounds within the definitions of formula: 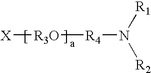
in which R₁ and R₂ are each independently selected from the group consisting of: hydrogen; an alkyl group having 1, 2; 3, 4, 5, 6, 7, 8, 9, or 10 carbon atoms, whether straight-chain or branched; or a radical of the formula: 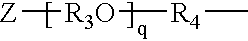
in which R₃ in each occurrence may be an alkyl group having any number of carbon atoms selected from 1, 2, 3, 4, 5, or 6, straight-chain or branched; R₄ in each occurrence is a straight-chain or branched alkyl bridging group having 1, 2, 3, 4, 5, or 6 carbon atoms; Z is a hydroxy group or alkyl group containing 1, 2, 3, 4, 5, or 6 carbon atoms, straight-chain or branched; q is any integer between 0 and 400; and wherein X is any of:
i) a hydroxy group or an alkyl group having any number of carbon atoms selected from 1, 2, 3, 4, 5, or 6; or
ii) a group 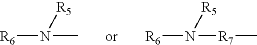
in which R₅ and R₆ are each independently selected from the group consisting of hydrogen; an alkyl group having 1, 2, 3, 4, 5, 6, 7, 8, 9, or 10 carbon atoms, whether straight-chain or branched; or 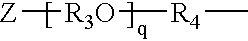
as defined above in which Z is a hydroxy group or an alkoxy group having 1, 2, 3, 4, 5, or 6 carbon atoms, and in which R₇ is a straight-chain or branched alkylene bridging group having 1, 2, 3, 4, 5, or 6 carbon atoms; or
iii) a moiety of the formula: 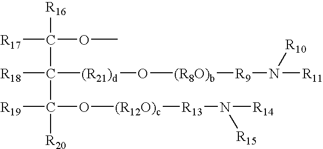
in which R₁₀, R₁₁, R₁₄, and R₁₅ are each independently selected from the group of: hydrogen; an alkyl group having 1, 2, 3, 4, 5, 6, 7, 8, 9, or 10 carbon atoms, straight-chain or branched; the moiety 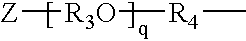
as defined above in which Z is a hydroxy or alkoxy group having 1, 2, 3, 4, 5, or 6 carbon atoms; R₈ and R₁₂ are each independently alkyl groups having 1, 2, 3, 4, 5, or 6 carbon atoms, straight-chain or branched; R₉, R₁₃, and R₂₁ are each independently selected from a straight-chain or branched alkyl bridging linkage having 1, 2, 3, 4, 5, or 6 carbon atoms; R₁₆, R₁₇, R₁₈, R₁₉, R₂₀ are each independently selected from hydrogen or an alkyl group having 1, 2, 3, 4, 5, or 6 carbon atoms; d is 0 or 1; a is any integer between 0 and 100, with the proviso that when X is a moiety of the formula given in iii) above, b and c may each independently be any integer in the range of 0 to 390, and the sum of a+b+c is any number between 2 and 400; and
C) mixing said first component with said second component, so as to form a mixture which cures to form a polyurea polymer,
wherein said one or more polyamino compounds comprise secondary polyether polyamino compounds.

2) A process according to claim 1 wherein the number of active hydrogen atoms present in said second composition is greater than the number of isocyanate groups present in said first composition.

3) A process according to claim 1 wherein the mixing of said first component with said second component is performed in the substantial absence of a chain extender.

4) A process according to claim 1 wherein said second composition comprises a secondary polyether polyamine triamine.

5) A process according to claim 1 wherein said second composition comprises a secondary polyether polyamine diamine.

6) A process according to claim 1 wherein said second composition comprises at least one material selected from the group consisting of diamine chain extenders; primary polyether polyamines; and pigments.

7) A process according to claim 1 wherein said organic isocyanate is an aliphatic isocyanate.

8) A process according to claim 7 wherein said organic isocyanate is selected from the group consisting of IPDI; dicyclohexylmethane di-isocyanate; HDI dimer; HDI trimer; and cyclohexyl di-isocyanate.

9) A process according to claim 1 wherein said organic isocyanate is an aromatic isocyanate.

10) A process according to claim 9 wherein said organic isocyanate is selected from the group consisting of: tetramethylxylene di-isocyanate; diphenylmethane di-isocyanate; toluene di-isocyanate, and all isomers of the foregoing.

11) A polyurea polymer which comprises the reaction product of an organic isocyanate with one or more secondary polyether polyamino compound(s) within the definitions of formula: 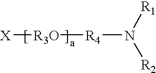
in which R₁ and R₂ are each independently selected from the group consisting of: hydrogen; an alkyl group having 1, 2, 3, 4, 5, 7, 8, 9, or 10 carbon atoms, whether straight-chain or branched; or a radical of the formula: 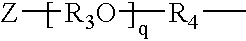
in which R₃ in each occurrence may be an alkyl group having any number of carbon atoms selected from 1, 2, 3, 4, 5, or 6, straight-chain or branched; R₄ in each occurrence is a straight-chain or branched alkyl bridging group having 1, 2, 3, 4, 5, or 6 carbon atoms; Z is a hydroxy group or alkyl group containing 1, 2, 3, 4, 5, or 6 carbon atoms, straight-chain or branched; q is any integer between 0 and 400; and wherein X is any of:
i) a hydroxy group or an alkyl group having any number of carbon atoms selected from 1, 2, 3, 4, 5, or 6; or
ii) a group 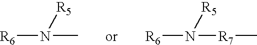
in which R₅ and R₆ are each independently selected from the group consisting of: hydrogen; an alkyl group having 1, 2, 3, 4, 5, 7, 8, 9, or 10 carbon atoms, whether straight-chain or branched; or 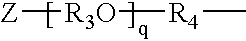
as defined above in which Z is a hydroxy group or an alkoxy group having 1, 2, 3, 4, 5, or 6 carbon atoms, and in which R₇ is a straight-chain or branched alkylene bridging group having 1, 2, 3, 4, 5, or 6 carbon atoms; or
iii) a moiety of the formula: 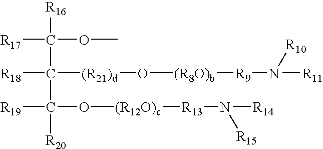
in which R₁₀, R₁, R₁₄, and R₁₅ are each independently selected from the group of hydrogen; an alkyl group having 1, 2, 3, 4, 5, 7, 8, 9, or 10 carbon atoms, straight-chain or branched; the moiety 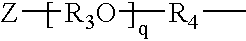
as defined above in which Z is a hydroxy or alkoxy group having 1, 2, 3, 4, 5, or 6 carbon atoms; % and R₁₂ are each independently alkyl groups having 1, 2, 3, 4, 5, or 6 carbon atoms, straight-chain or branched; R₉, R₁₃, and R₂₁ are each independently selected from a straight-chain or branched alkyl bridging linkage having 1, 2, 3, 4, 5, or 6 carbon atoms; R₆, R₁₇, R₁₈, R₁₉, R₂₀ are each independently selected from hydrogen or an alkyl group having 1, 2, 3, 4, 5, or 6 carbon atoms; d is 0 or 1; a is any integer between 0 and 100, with the proviso that when X is a moiety of the formula given in iii) above, b and c may each independently be any integer in the range of 0 to 390, and the sum of a+b+c is any number between 2 and 400;
wherein said polyurea polymer has a tear strength of at least 550 pli as measured using ASTM test method D-624.

12) A polymer according to claim 11 wherein said secondary polyether polyamino compound(s) comprises a secondary polyether polyamine triamine.

13) A polymer according to claim 11 wherein said secondary polyether polyamino compound(s) comprises a secondary polyether polyamine diamine.

14) A polymer according to claim 11 wherein said polymer includes at least one material selected from the group consisting of: diamine chain extenders; primary polyether polyamines; and pigments in its polymer backbone.

15) A polymer according to claim 11 which includes an aliphatic repeating unit that is derived from an aliphatic isocyanate.

16) A polymer according to claim 15 wherein said organic isocyanate is selected from the group consisting of: IPDI; dicyclohexylmethane di-isocyanate; HDI dimer; HDI trimer; and
cyclohexyl di-isocyanate.

17) A polymer according to claim 11 wherein said organic isocyanate is an aromatic isocyanate.

18) A polymer according to claim 17 wherein said organic isocyanate is selected from the group consisting of: tetramethylxylene di-isocyanate; diphenylmethane di-isocyanate; toluene di-isocyanate, and all isomers of the foregoing.

19) A polyurea polymer according to claim 11 wherein said polyurea polymer is a prepolymer having a molecular weight between about 500 and about 20,000 (weight average molecular weight) and an isocyanate content of between about 1% and 38% by weight based on the total weight of said prepolymer.

20) A prepolymer according to claim 11 having a viscosity of between about 80 and 10,000 centipoise at 25 degrees C.
